(19) United States
(12) Patent Application Publication
(10) Pub. No.: US 2025/0128258 A1
(43) Pub. Date: Apr. 24, 2025

(54) HIGH-THROUGHPUT ISOLATION OF PLASMA AND NANO/MICROPARTICLES FROM BLOOD AND CULTURE MEDIA USING CURVED MICROCHANNELS

(71) Applicant: Nanyang Technological University, Singapore (SG)

(72) Inventors: Han Wei HOU, Singapore (SG); Sheng Yuan LEONG, Singapore (SG); Hui Min TAY, Singapore (SG); Hong Boon ONG, Singapore (SG); Wan Wei LOK, Singapore (SG)

(21) Appl. No.: 18/492,487

(22) Filed: Oct. 23, 2023

(30) Foreign Application Priority Data
Oct. 18, 2023 (SG) 10202302946R

(51) Int. Cl. B01L 3/00

(52) U.S. Cl. CPC B01L 3/502761; B01L 3/50273; B01L 2200/027; B01L 2200/0636; B01L 2200/0652; B01L 2300/0867

(57) ABSTRACT

Herein disclosed is a microfluidic device comprising: semi-spiral-shaped channels in fluid communication with (i) at least two inlet ports and (ii) at least two outlet ports, wherein the at least two inlet ports comprise: a sample inlet port and a sheath inlet port, wherein the sample inlet port is in fluid communication with sample inlet channels, each of the sample inlet channels is connected to one semi-spiral-shaped channel, and wherein the sheath inlet port is in fluid communication with sheath inlet channels, each of the sheath inlet channels is connected to one semi-spiral-shaped channel; wherein the at least two outlet ports comprise a first outlet port and each of the semi-spiral-shaped channels has a first outlet channel connected to the first outlet port, and wherein each first outlet channel is longer than any other outlet channel connected to the same semi-spiral-shaped channel. A method of fractionating particles is also disclosed.

### CROSS-REFERENCE TO RELATED APPLICATION

This application claims the benefit of priority of Singapore Patent Application No. 10202302946R, filed 18 Oct. 2023, the content of it being hereby incorporated by reference in its entirety for all purposes.

### TECHNICAL FIELD

The present disclosure relates to a microfluidic device for isolating one or more particles from a sample.

### BACKGROUND

Sepsis is generally understood as the dysregulated immune response to bacterial infections which can result in life threatening conditions. Early detection of sepsis tends to be important as mortality rate increases by 7.6% every hour. As traditional sepsis detection method using blood culture assay is slow (e.g., takes up to about 48 hours), broad-spectrum antibiotics tend to be administered upfront which may cause detrimental effects to patients. Polymerase chain reaction (PCR) may offer a faster and culture-free alternative (compared to aforesaid traditional blood culture assay) for bacterial detection, but suffers from host cells' deoxyribonucleic acid (DNA) contamination due to incomplete removal of blood cells. Moreover, traditional bacteria isolation requires laborious and time-consuming multi-step centrifugation, limiting their adoption in time-sensitive sepsis diagnostics in clinical settings.

Other than bacteria, extracellular vesicles (EVs) or viruses may often be present in the blood from patients with cancers or infectious diseases. Due to their nanoscale sizes (30 nm to 200 nm), EVs and viruses isolation require laborious ultracentrifugation (UC) which tends to be inefficient, inconsistent, and costly. Moreover, centrifugation protocols may often be non-standardized, which may cause incomplete cell removal during plasma extraction and result in high background noise for the detection of low abundance biomarkers.

In biomanufacturing, EVs and viruses tend to be common vectors used in cell and gene therapy. Their manufacturing often requires robust quality control measures to ensure the safety of manufactured EV/virus or cell products. However, traditional isolation methods including UC and/or chromatography tend to be costly and not suitable for small volume processing. Moreover, due to difficulty with inline monitoring of EV/virus production, quality check of EV/virus may often be conducted only near the end or at the end of the manufacturing process.

There is thus a need to provide for a solution that addresses one or more of the limitations mentioned above. The solution should be able to address clinical need for a more efficient and rapid method to isolate blood-borne bacteria, EVs or viruses for point-of-care clinical diagnostics. The solution should also provide for inline monitoring capability of EV/virus production process.

### SUMMARY

In a first aspect, there is provided a microfluidic device comprising:
semi-spiral-shaped channels in fluid communication with (i) at least two inlet ports and (ii) at least two outlet ports,
wherein the at least two inlet ports comprise:
   a sample inlet port and a sheath inlet port,
   wherein the sample inlet port is in fluid communication with sample inlet channels, each of the sample inlet channels is connected to one semi-spiral-shaped channel, and
   wherein the sheath inlet port is in fluid communication with sheath inlet channels, each of the sheath inlet channels is connected to one semi-spiral-shaped channel;
wherein the at least two outlet ports comprise a first outlet port and each of the semi-spiral-shaped channels has a first outlet channel connected to the first outlet port, and
wherein each first outlet channel is longer than any other outlet channel connected to the same semi-spiral-shaped channel.

In another aspect, there is provided a method for fractionating particles of different sizes, the method comprising:
providing the microfluidic device describes in various embodiments of the first aspect;
introducing a sample into the sample inlet port and introducing a sheath fluid into the sheath inlet port to form a mixture in the semi-spiral-shaped channels;
driving the mixture through the semi-spiral-shaped channels; and recovering a first fraction of particles from the first outlet port.

### BRIEF DESCRIPTION OF THE DRAWINGS

The drawings are not necessarily to scale, emphasis instead generally being placed upon illustrating the principles of the present disclosure. In the following description, various embodiments of the present disclosure are described with reference to the following drawings, in which:

FIG. 1A is a photograph of one non-limiting example of the microfluidic device of the present disclosure. 100 denotes the sheath inlet (i.e., sheath inlet port), 102 denotes the sample inlet (i.e., sample inlet port), 104 denotes outlet 1 (O1), 106 denotes outlet 2 (O2), 108a denotes the outer wall of the semi-spiral-shaped channel (depicted using the broken line), and 108b denotes the inner wall of the semi-spiral-shaped channel (depicted using the broken dotted line). Throughout the drawings, O1 denotes outlet 1 (also herein referred to as the first outlet) and O2 denotes outlet 2 (also herein referred to as the second outlet). In various non-limiting embodiments, there may be one or more first outlets and one or more second outlets. In this instance, FIG. 1A depicts one first outlet and one second outlet.

FIG. 1B illustrates one of the underlying working principles of the present microfluidic device. The leftmost image 1000 depicts the inlet region, the center image 1002 depicts the outlet region, and the rightmost image 1004 depicts a cross-section of the semi-spiral-shaped channel. 108b denotes for the inner wall of the semi-spiral-shaped channel, 110a denotes the sample which is introduced away from the inner wall 108b (i.e., proximal to outer wall), and 110b denotes the sheath fluid which is introduced proximal to the inner wall 108b.

FIG. 1C is a schematic diagram depicting the microfluidic device of FIG. 1A in a system that includes the microfluidic device of FIG. 1A. The system includes the sheath inlet in fluid communication with a buffer source, which is delivered to the sheath inlet via a pump 120b (e.g., a peristaltic pump, pressure pump, syringe pump). The system includes the sample inlet in fluid communication with a sample source (e.g., blood sample), which is delivered to the sample inlet via a pump 120a (e.g., a peristaltic pump, pressure pump, syringe pump). 110b denotes for the sheath fluid (i.e., buffer source), 110c denotes for the blood sample, 122 denotes for the present microfluidic device illustrating the semi-spiral-shaped channels, 124 denotes the bacteria isolated, and 126 denotes for the sepsis diagnosis using the bacteria 124.

FIG. 1D shows a photograph of the system of FIG. 1C. 110b denotes for the sheath fluid, 110c denotes for the blood sample, 120a and 120b denote the blood sample pump and sheath fluid pump, respectively, and 122 denotes for the present microfluidic device.

FIG. 1E shows the photograph (left image) of the isolated bacteria from outlet 1 (O1) of the microfluidic device shown in FIG. 1A and the photograph (right image) of the red blood cells (RBCs) from outlet 2 (O2) of the same microfluidic device separated from the bacteria. The isolated bacteria and separate RBCs demonstrate the successful depletion of RBCs from the bacteria (about 104-fold to 105-fold depletion of RBCs) using the microfluidic device of the present disclosure.

FIG. 2 shows fluorescent images of 2 μm beads in top row images. High speed imaging of red blood cells (RBCs) and its z-projected images (indicative of platelet trajectories (dark band)) are shown in center row images. High speed imaging during blood flow at the device outlet bifurcation is shown in bottom row images.

FIG. 3A shows the high-speed images of Escherichia coli (EC) spiked in sheath buffer.

FIG. 3B shows the bacteria concentration of EC before and after sorting.

FIG. 3C shows the separation yield of different bacteria at low concentrations (about 100 CFU/mL whole blood).

FIG. 3D is a table indicating the EC separation performance at about 10 CFU/mL whole blood.

FIG. 4A is a schematic illustration of the separation principle for direct extraction of plasma and extracellular vesicles (EVs) from blood using a microfluidic device of the present disclosure. 4000 denotes the inlet (top view), 4002 denotes outlet (top view), and 4004 denotes cross-sectional view of the semi-spiral-shaped channel. 108b denotes the inner wall.

FIG. 4B is a plot showing recovery of 50 nm and 500 nm beads in O1.

FIG. 4C shows fluorescent images of 50 nm beads (two images on left) and 500 nm beads (two images on right) at the outlets of the present microfluidic device.

FIG. 4D shows high speed images of processing blood with cell removal into waste outlet (i.e., outlet 2 (O2)) of the present microfluidic device.

FIG. 4E is a plot of the representative size distribution of particles isolated from blood using the present microfluidic device.

FIG. 4F is a plot of the yield of particles isolated from blood using the present microfluidic device.

FIG. 4G is a plot of protein concentration comparing sorted plasma from the present microfluidic device and centrifuged plasma.

FIG. 4H is a plot of representative size distribution of CD9+ particles (indicative of EVs) in bio-banked plasma processed with the present microfluidic device.

FIG. 4I is a plot of the yield of CD9+ particles (EV marker) in bio-banked plasma processed with the present microfluidic device.

FIG. 5A is a schematic illustration of the separation principle of virus from culture media using a microfluidic device of the present disclosure. 5000 denotes a cross-section view of the semi-spiral-shaped channel. 108b denotes the inner wall.

FIG. 5B is a schematic illustration showing expression of green fluorescent protein (GFP) in human aortic endothelial cell (HAoEC) after successful viral transduction. 50 denotes before transduction, 52 denotes the GFP gene, and 54 denotes after transduction (expression of GFP).

FIG. 5C shows fluorescent and brightfield imaging indicating upregulation of GFP in HAoEC incubated with O1 eluent compared to O2 eluent and phosphate buffer saline (PBS, negative control).

FIG. 6A demonstrates a microfluidic device of the present disclosure, which has multiple semi-spiral curved channels. As can be seen, four semi-spiral-shaped channels are configured. Either one of the inlets 100a, 100b can be configured as the sample inlet, and the other as the sheath fluid inlet. 104a and 104b denote the various outlets 1 (O1), i.e., first outlets. 106a and 106b denote the various outlets 2 (O2), i.e., second outlets.

FIG. 6B shows the same microfluidic device of FIG. 6A, except in this instance the bottom inlet is configured as the sample inlet 102 and the top inlet is configured as the sheath fluid inlet 100. 104a and 104b denote the various outlets 1 (O1), i.e., first outlets. 106a and 106b denote the various outlets 2 (O2), i.e., second outlets.

FIG. 7 shows a schematic of the microfluidic device of FIG. 1A, particularly indicating how the length of certain structures of the present microfluidic device can be identified. The length of a sample inlet channel can be measured from point 7000a starting at the circumference of the sample inlet port to point 7000b, which meets the sheath inlet channel. The length of a sheath inlet channel can be measured from point 7100a starting at circumference of the sheath inlet port to point 7100b, which meets the sample inlet channel. The length of the first outlet channel can be measured from point 7200a to point 7200b at the circumference of the first outlet port. The length of the second outlet channel can be measured from point 7300a to point 7300b at the circumference of the second outlet port.

### DETAILED DESCRIPTION

The following detailed description refers to the accompanying drawings that show, by way of illustration, specific details and embodiments in which the present disclosure may be practised.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The present disclosure describes a microfluidic device for isolating one or more particles from a sample. For brevity, the microfluidic device is herein exchangeably referred to as “present device” and “device”. The one or more particles can be microparticles and/or nanoparticles. In the context of the present disclosure, especially in biological fluid (e.g., blood, urine, any culture medium), the term “nanoparticles” may refer to particles, such as but not limited to, extracellular vesicles (e.g., 50 nm to 1000 nm), virus (e.g., 20 nm to 500 nm), lipoproteins (e.g., 10 nm to 1000 nm), proteins, DNAs, and ribonucleic acids (RNAs) (e.g., 10 nm or less). Such nanoparticles tend to have a size of 1000 nm or less. In the context of the present disclosure, especially in biological fluid (e.g., blood, urine, any culture medium), the term “microparticles” may refer to particles, such as but not limited to, bacteria (e.g., 0.5 μm to 2 μm), platelets and platelet fragments (1 μm to 4 μm), and blood cells (5 μm to 20 μm). Such microparticles tend to include particles having a size greater than 1000 nm. The sample can be a liquid sample. The sample can be a biological sample, such as a blood sample, a urine sample, etc. The sample can be a culture medium containing particles to be isolated and/or fractionated (i.e., sorted).

The microfluidic device is a membrane-free particle fractionation tool, i.e. no membrane is present for isolating and fractionation of particles of different sizes. The microfluidic device is capable of separating small nanoparticles and microparticles (e.g. microscale blood particles (2 μm or less) from other particles in a sample) based on differential Dean migration effects in two or more semi-spiral-shaped microchannels. With the Dean migration effect, the microfluidic device allows a single-step and continuous purification of small bioentities such as plasma, virus, extracellular vesicles, bacteria and platelets directly from blood and culture media at the same time efficiently depleting larger cells. The short processing time (less than 20 min/mL blood) and straightforward setup of a particle isolation system afforded by the microfluidic device can further advantageously be readily automated to isolate low abundance (about 10 CFU/mL) bacteria from blood for point-of-care sepsis diagnostics. Low abundance microorganisms are microorganisms that exist in low numbers or at very low concentrations in a particular environment, such as the human gut, soil, water, blood, urine, or any sample. These microorganisms tend to be difficult to detect and study due to their low abundance and may be overshadowed by more abundant microorganisms. Following this, low abundance bacteria refers to bacteria that exist in low numbers or at very low concentrations in a particular environment. Understandably, low abundance bacteria tend to have a concentration in a sample that may be too low and/or too difficult to be efficiently isolated, or even isolated, using traditional methods.

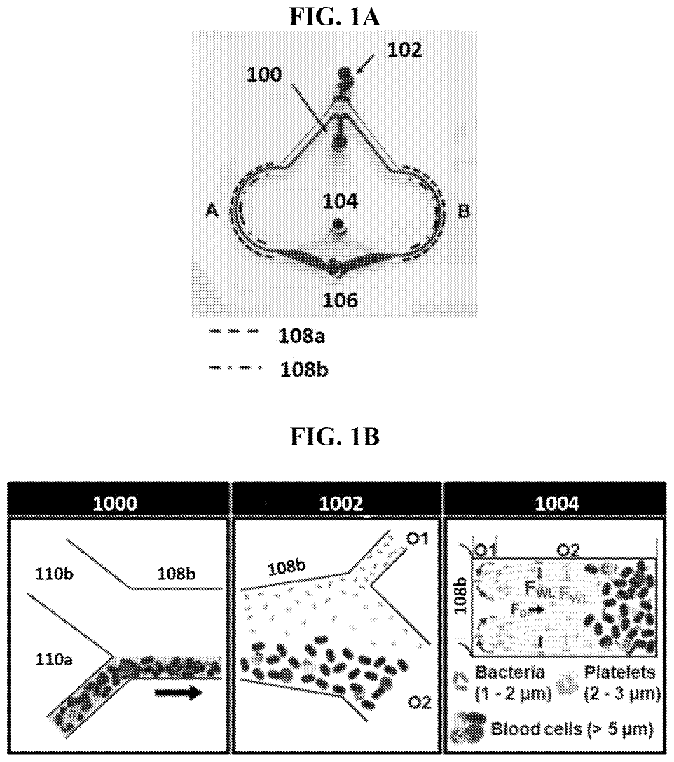

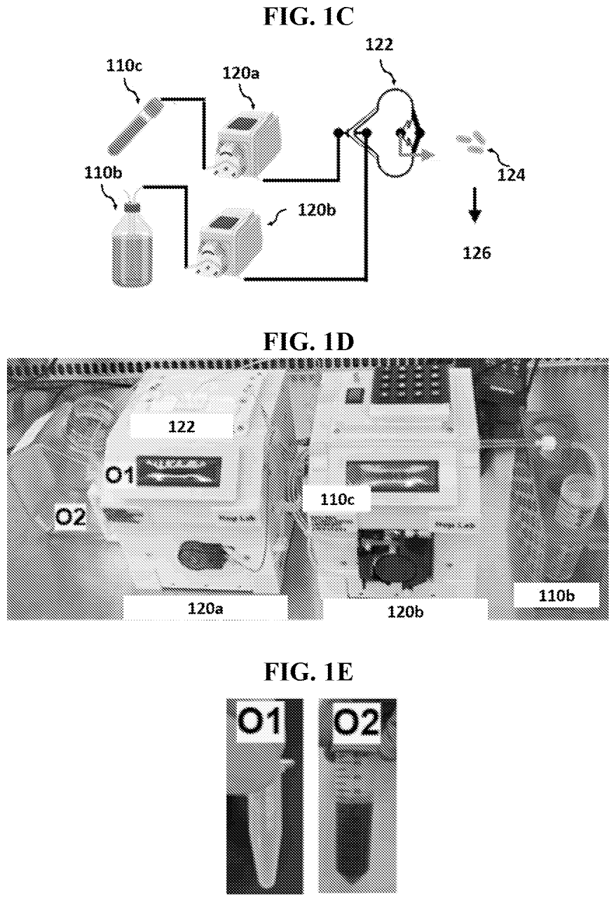

As one non-limiting example, the present device is capable of sorting particles, successfully fractionating small microparticles (e.g., 50 nm to 3 μm) based on differential Dean flow-induced particle migration in two or more semi-spiral-shaped microchannels. Based on such working principle, the microfluidic device is capable of and developed to include a pair of semi-spiral-shaped channels (i.e. mirror-imaged semi-spiral-shaped channels), an example of which is illustrated in FIG. 1A. The microfluidic device is also capable of and developed to include multiple semi-spiral-shaped channels and/or multiple mirror-image semi-spiral-shaped channels. Advantageously, even with the two or more semi-spiral-shaped channels, the microfluidic device is still able to sort and isolate particles via a single-step and continuous separation, even for low abundance bacteria (10 to 100 CFU/mL) or platelets from blood, with ultra-high throughput of more than 1 mL blood in 10 minutes. The developed device is configurable to isolate plasma, EVs and/or viruses from a sample (e.g. blood and culture medium).

Compared to traditional blood culture which requires more than 10 mL blood and takes at least 48 to 120 hours to process, the present microfluidic device is able to isolate bacteria from an even lower amount of blood and at a considerably faster time. Also, while PCR may provide a faster alternative (compared to traditional blood culture) for sepsis diagnostics using lower blood volume (about 1 mL), the blood may still have to be traditionally centrifuged a considerable number of times to isolate bacteria from blood cells before conducting PCR. Moreover, the high blood cell concentration (about 5 billion cells/mL) poses significant technical challenges to isolate low abundance bacteria (about 10 bacteria/mL). The lack of onsite centrifuge and trained operators also demands the shipping of blood samples to off-site laboratory for centrifugation. This not only caused the golden hours for early detection to be missed, but also places the sample susceptible to cell degradation that may occur during the delay in processing, which then renders false positive results due to blood cells' DNA contamination.

Similarly, detection of EVs or viruses tends to be contaminated by ex vivo cell lysis or platelet activation after blood draw due to the delayed centrifugation of blood. To avoid cellular contamination, platelet-free plasma is traditionally extracted using 3 to 4 steps of centrifugation which is laborious and may be impractical in clinical settings. The inefficient ultracentrifugation for EV/virus isolation also requires high sample volume, which increases the burden of patient in clinical diagnostics or manufacturing cost in EV/virus production.

The present microfluidic device is able to circumvent and/or address aforesaid limitations and difficulties. The present microfluidic device enables direct isolation of plasma, EVs, viruses and low abundance bacteria (about 10 CFU/mL) in a centrifuge-free manner. With a straightforward setup (e.g., using two syringe pumps), the microfluidic device can be readily automated for higher process consistency compared to traditional manual centrifugation. Its miniaturised configuration and short processing time allow fast blood processing after blood draw, avoiding potential blood degradation that can happen during the long transportation of a sample in cases of traditional sampling requiring the sample to be sent to an off-site laboratory for centrifugation. By avoiding transportation, the present device accelerates the diagnostic process and increases survival rate of sepsis patients. The low blood volume required (about 1 mL) also reduces patients' discomfort, especially children due to their lower total blood volume compared to adults.

Besides clinical diagnostics, the microfluidic device enables EV/virus isolation from low volume of culture medium for rapid characterization in EV/virus production. It provides an easier inline sampling method with minimal sample loss to monitor the sophisticated manufacturing pipelines compared to the expensive ultracentifugation or chromatography that only allow endpoint measurements.

Details of various embodiments of the present microfluidic device and a method for fractionating particles of different sizes, and advantages associated with the various embodiments are now described below. Where the embodiments and advantages are already described in the examples section further hereinbelow, they shall not be iterated for brevity.

The present disclosure relates a microfluidic device. The microfluidic device can be used for isolating particles from a sample, and/or fractionation of particles of different sizes.

In various embodiments, the microfluidic device may comprise semi-spiral-shaped channels in fluid communication with (i) at least two inlet ports and (ii) at least two outlet ports. For example, the microfluidic device may comprise semi-spiral-shaped channels in fluid communication with (i) a pair of inlet ports and (ii) at least two outlet ports. The at least two outlet ports, as an example, may comprise two, three, four, or more outlet ports.

In various embodiments, the at least two inlet ports (e.g., the pair of inlet ports) may comprise a sample inlet port and a sheath inlet port. For example, the at least two inlet ports may comprise at least one sample inlet port and at least one sheath inlet port. In various embodiments, the sample inlet port may be in fluid communication with sample inlet channels, each of the sample inlet channels may be connected to one semi-spiral-shaped channel (e.g., each of the sample inlet channels may be connected proximal to an outer wall of one semi-spiral-shaped channel). In various embodiments, the sheath inlet port may be in fluid communication with sheath inlet channels, each of the sheath inlet channels may be connected to one semi-spiral-shaped channel (e.g., each of the sheath inlet channels may be connected proximal to an inner wall of one semi-spiral-shaped channel). Such configuration of the sample inlet channel(s) and the sheath inlet channel(s) helps set up the Dean flow in each of the semi-spiral-shaped channels.

In various embodiments, the at least two outlet ports may comprise a first outlet port and each of the semi-spiral-shaped channels has a first outlet channel connected to the first outlet port, and wherein each first outlet channel is longer than any other outlet channel (or any other outlet channels, such as one, two, three, or more other outlet channels) connected to the same semi-spiral-shaped channel. Said differently, there may be multiple outlet channels extending from a semi-spiral-shaped channel, wherein one of the multiple outlet channels is the first outlet channel, which is longer than the other outlet channels that extend from the same semi-spiral-shaped channel as the first outlet channel.

In various embodiments, wherein the sheath inlet port may be configured to have a sheath fluid introduced at a higher flow rate than a sample introduced into the sample inlet port.

In various embodiments, the sheath inlet channels may be configured to have a sheath fluid driven toward the semi-spiral-shaped channels at a higher flow rate than a sample in the sample inlet channels driven toward the semi-spiral-shaped channels.

In various embodiments, the sample inlet port may be defined as having a width of 50 μm to 1000 μm, 100 μm to 1000 μm, 200 μm to 1000μ, 300 μm to 1000 μm, 400 μm to 1000 μm, 500 μm to 1000 μm, 600 μm to 1000 μm, 700 μm to 1000 μm, 800 μm to 1000 μm, 900 μm to 1000 μm, 150 μm to 250 μm, etc.

In various embodiments, the sheath inlet port may be defined as having a width of 50 μm to 1000 μm, 100 μm to 1000 μm, 200 μm to 1000 μm, 300 μm to 1000 μm, 400 μm to 1000 μm, 500 μm to 1000 μm, 600 μm to 1000 μm, 700 μm to 1000 μm, 800 μm to 1000 μm, 900 μm to 1000 μm, 500 μm to 600 μm, etc.

In various embodiments, the sample inlet channels may comprise or may consist of two sample inlet channels, which are bifurcated from the sample inlet port to define the two sample inlet channels.

In various embodiments, the sheath inlet channels may comprise or may consist of two sheath inlet channels, which are bifurcated from the sheath inlet port to define the two sheath inlet channels.

In various embodiments, the sample inlet channels may all have the same dimensions, and/or the sheath inlet channels may all have the same dimensions, and/or the semi-spiral-shaped channels may all have the same dimensions.

In various embodiments, each of the sample inlet channels may be defined as having a width of 50 μm to 1000 μm, 100 μm to 1000 μm, 200 μm to 1000 μm, 300 μm to 1000 μm, 400 μm to 1000 μm, 500 μm to 1000 μm, 600 μm to 1000 μm, 700 μm to 1000 μm, 800 μm to 1000 μm, 900 μm to 1000 μm, etc. In various embodiments, each of the sample inlet channels may be defined as having a length of 100 mm or more. In various non-limiting instances, shorter sample inlet channels may be used if fractionation of the particles works.

In various embodiments, each of the sheath inlet channels may be defined as having a width of 50 μm to 1000 μm, 100 μm to 1000 μm, 200 μm to 1000 μm, 300 μm to 1000 μm, 400 μm to 1000 μm, 500 μm to 1000 μm, 600 μm to 1000 μm, 700 μm to 1000 μm, 800 μm to 1000 μm, 900 μm to 1000 μm, etc. In various embodiments, each of the sheath inlet channels may be defined as having a length of 100 mm or more. In various non-limiting instances, shorter sheath inlet channels may be used if fractionation of the particles works.

In various embodiments, each of the semi-spiral-shaped channels may be defined as having a width of 200 μm to 1000 μm, 200 μm to 800 μm (e.g., 300 μm to 1000 μm, 400 μm to 1000 μm, 500 μm to 1000 μm, 600 μm to 1000 μm, 700 μm to 1000 μm), and/or a height of 30 μm to 300 μm (e.g., 50 μm to 300 μm, 100 μm to 300 μm, 200 μm to 300 μm), and/or a length of 5 mm to 35 mm (e.g., 10 mm to 35 mm, 15 mm to 35 mm, 20 mm to 35 mm, 25 mm to 35 mm, 30 mm to 35 mm), and/or a radius of curvature of 3 mm to 10 mm (e.g., 4 mm to 10 mm, 5 mm to 10 mm, 6 mm to 10 mm, 7 mm to 10 mm, 8 mm to 10 mm, 9 mm to 10 mm). The radius of curvature of the semi-spiral-shaped channel is the distance measured from a center of the semi-spiral-shaped channel's cross-section to the “centripetal” center, such that the radius measured is orthogonal to the motion of fluid flowing in the semi-spiral-shaped channel. In other words, the centripetal center is a fixed point of the center of curvature of the fluid flow path.

In various embodiments, each first outlet channel may be defined as having a width of 25 μm to 500 μm, 50 μm to 500 μm, 100 μm to 500 μm, 200 μm to 500 μm, 300 μm to 500 μm, 400 μm to 500 μm, etc. In various embodiments, each first outlet channel may be defined as having a length of 100 mm or more. In various non-limiting instances, shorter first outlet channel(s) may be used if fractionation of the particles works, albeit the first outlet channel(s) remains longer than any other outlet channel(s).

In certain non-limiting embodiments, the at least two outlet ports may comprise or consist of two outlet ports, wherein the two outlet ports include the first outlet port and a second outlet port, and wherein each of the semi-spiral-shaped channels has a second outlet channel connected to the second outlet port. Understandably, such configuration may be extended to non-limiting embodiments where the at least two outlet ports may comprise or may consist of three outlet ports, four outlet ports, etc. That is to say, as an example, where there are three outlet ports or four outlet ports, each of the the semi-spiral-shaped channels has, respectively, (i) a third outlet channel connected to the third outlet port or (ii) a third outlet channel and a fourth outlet channel connected to the third and fourth outlet ports, respectively. In other words, in various embodiments, each of the semi-spiral-shaped channels may have multiple outlet channels each connected to a corresponding individual outlet port (e.g., two outlet channels may not connect to one outlet port).

In various embodiments, each second outlet channel may be defined as having a width of 800 μm to 3000 μm, 1000 μm to 3000 μm, 2000 μm to 3000 μm, etc. In various embodiments, the length of the second outlet channel (and/or any other outlet channel) may scale proportionally to the first outlet channel. In other words, if a longer first outlet channel is used, then a longer second outlet channel (and/or any other outlet channel) may be used (albeit the other outlet channel(s), such as the second outlet channel, is still shorter in length than the first outlet channel). As a non-limiting example, a second outlet channel (and/or any other outlet channel(s)) may be configured to be 3000 μm or more, but still shorter than the first outlet channel.

The present disclosure also relates to a method for fractionating particles of different sizes involving the microfluidic device described in various embodiments of the first aspect. Embodiments and advantages described for the microfluidic device of the first aspect can be analogously valid for the present method subsequently described herein, and vice versa. Where the various embodiments and advantages have already been described above and in the examples section further hereinbelow, they shall not be iterated for brevity.

In various embodiments, the method may comprise providing the microfluidic device describes in various embodiments of the first aspect, introducing a sample into the sample inlet port and introducing a sheath fluid into the sheath inlet port to form a mixture in the semi-spiral-shaped channels, driving the mixture through the semi-spiral-shaped channels, and recovering a first fraction of particles from the first outlet port. In various embodiments, introducing the sample into the sample inlet port and

introducing the sheath fluid into the sheath inlet port may comprise introducing the sheath fluid at a higher flow rate than the sample.

In various embodiments, introducing the sample into the sample inlet port and introducing the sheath fluid into the sheath inlet port may comprise introducing the sample toward the outer wall of each of the semi-spiral-shaped channel and introducing the sheath fluid toward the inner wall of each of the semi-spiral-shaped channel.

In various embodiments, driving the mixture through the semi-spiral-shaped channels may comprise driving the mixture to flow in each of the semi-spiral-shaped channels with (i) a Reynolds number of 20 to 500 (e.g., 50 to 500, 100 to 500, 200 to 500, 300 to 500, 400 to 500, 20 to 100) and (ii) a Dean number of 2 to 50 (e.g., 5 to 50, 10 to 50, 20 to 50, 30 to 50, 40 to 50, 2 to 10). In the context of the present disclosure, Reynolds number means ρνL/μ, wherein ρ represents density of a fluid, ν represents velocity of the fluid, L represents characteristic length of a channel in which the fluid flows, and u represents viscosity of the fluid. In the context of the present disclosure, Dean number refers to a product of the Reynold number (based on axial flow ν through a channel of diameter D) and the square root of the curvature ratio, i.e., Re√[D/(2R_{c})], wherein R_{c} is the radius of curvature of the path of the channel.

In various embodiments, recovering the first fraction of particles from the first outlet port may comprise recovering particles in the same sample having the smallest diameters compared to particles recovered in any other outlet channel.

The word “substantially” does not exclude “completely” e.g. a composition which is “substantially free” from Y may be completely free from Y. Where necessary, the word “substantially” may be omitted from the definition of the present disclosure.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Unless specified otherwise, the terms “comprising” and “comprise”, and grammatical variants thereof, are intended to represent “open” or “inclusive” language such that they include recited elements but also permit inclusion of additional, unrecited elements.

### EXAMPLES

The present disclosure relates to microfluidic device for isolating one or more particles from a sample. The present disclosure also relates to a method of isolating one or more particles from a sample involving the microfluidic device.

The microfluidic device and method are described in further details, by way of non-limiting examples, as set forth below.

### Example 1: One Non-Limiting Example of Device Configuration

A 2-inlet, 2-outlet mirror-imaged dual curved microfluidic device was developed for the purpose of demonstrating a non-limiting example of the microfluidic device of the present disclosure, and is not intended to limit the microfluidic device to such demonstrated example.

As the microfluidic device of the present disclosure has more than one curved channel, the microfluidic device can be referred to as a “multi-curved microfluidic device” in the present disclosure. The multi-curved microfluidic device was used to demonstrate rapid separation of plasma, EVs, viruses, bacteria, platelets from whole blood samples and various culture media directly with low or no contamination of blood cells. The developed microfluidic device affords a label-free, low-cost and miniaturized isolation method, which can be automated in point-of-care settings, such as hospital or clinics, to provide immediate blood processing after blood drawn for clinical diagnostics, or deployed in EV/virus manufacturing sites for inline EV/virus isolation for process monitoring.

In various non-limiting examples of the 2-inlet, 2-outlet microfluidic device, this configuration of the device includes two mirror-imaged arc-shaped microchannel subunits (FIG. 1A). The microchannel subunits (also termed herein “semi-spiral-shaped channels”, and “microchannels” for brevity), or even the entire device, are fabricated in polydimethylsiloxane (PDMS) using standard soft lithography techniques. The sample inlet and sheath inlet are connected to each microchannel subunit at the outer and inner wall of the microchannel, respectively. The bifurcated outlets of each microchannel subunit comprise of outlet 1 (O1, top-denoted 104 in FIG. 1A) and outlet 2 (O2, bottom-denoted 106 in FIG. 1A) at the inner and outer wall of each microchannel, respectively. Both O1s and O2s from each subunit are merged as common outlets (form two common outlets).

The sample inlet (i.e., sample inlet port-denoted 102 in FIG. 1A) extends to two channels (i.e., sample inlet channels) that is equally split, further furcated into 2 microchannel subunits with each sample inlet channel in fluid communication with one semi-spiral-shaped channel (i.e. one microchannel subunit) (e.g., FIG. 1A). The split from the sample inlet port into the two sample inlet channels may be configured at the sample inlet port so that the flow may be more stable when entering the semi-spiral-shaped channels. Also, the split from the sample inlet port into two sample inlet channels may be configured at any position upstream of (i.e., before) the further furcation into the two semi-spiral-shaped channels (i.e., before the position where the sample meets the sheath fluid).

The sheath inlet port (denoted 100 in FIG. 1A) extends to two sheath inlet channels that is equally split, further furcated into 2 microchannel subunits with each sheath inlet channel in fluid communication with one semi-spiral-shaped channel (i.e. one microchannel subunit) (e.g., FIG. 1A). The split from the sheath inlet port into the two sheath inlet channels may be configured at the sheath inlet port so that the flow may be more stable when entering the semi-spiral-shaped channels. Also, the split from the sheath inlet port into the two sheath inlet channels may be configured at any position upstream of (i.e., before) the further furcation into the two semi-spiral-shaped channels (i.e., before the position where the sample meets the sheath fluid).

At the end of each semi-spiral-shaped channel, there may be a trapezoidal region (e.g., see FIG. 1B center image) which the outlet(s) furcates from. That is to say, for example, outlet 1 channel (e.g., for bacteria collection) starts from the end of the trapezoidal region.

The outlet 2 channel (e.g., waste) also starts from end of the trapezoidal region.

The dimensions of various structures of the present microfluidic device are already described in the detailed description and hence for brevity shall not be reiterated in detail. For example, the sample and sheath inlet ports, as well as the sample and sheath inlet channels, can have a width of 50 μm to 1000 μm. In various non-limiting instances, the sample inlet channels can all have the same dimensions, and/or the sheath inlet channels can all have the same dimensions. In various non-limiting instances, the semi-spiral-shaped channels can all have the same dimensions. In various non-limiting examples, each of the semi-spiral-shaped channels can be defined as having: a width of 200 μm to 1000 μm, and/or a height of 30 μm to 300 μm, and/or a length of 5 mm to 35 mm, and/or a radius of curvature of 3 mm to 10 mm. In various non-limiting examples, each first outlet channel can be defined as having a width 25 μm to 500 μm, and/or each second outlet channel can be defined as having a width of 800 μm to 3000 μm. In various instances, the length of the first outlet channel can be 100 mm or longer. In various instances, length of the other outlet channel(s), such as the second outlet channel, can be 3000 μm or more, but still shorter than the first outlet channel.

In various examples, the sheath fluid is introduced at a higher flow rate than the sample. With the geometrical configuration and operating flow conditions, blood microparticles such as bacteria (about 1 μm) or platelets (about 2 to 4 μm) are eluted to O1, while larger blood particles (more than 5 μm) including red blood cells (RBCs, 6 to 8 μm), and white blood cells (7 to 20 μm) are fractionated into O2.

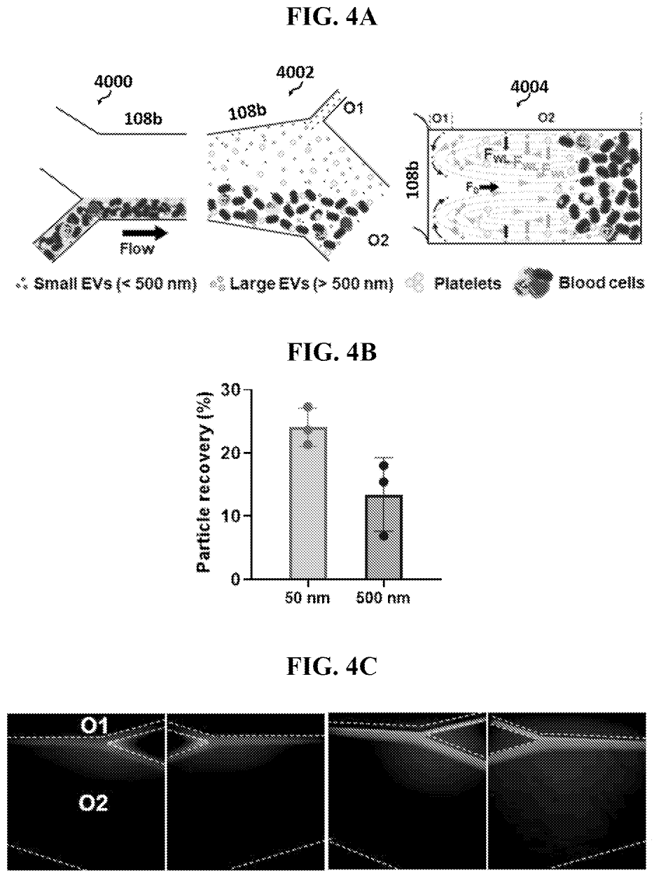

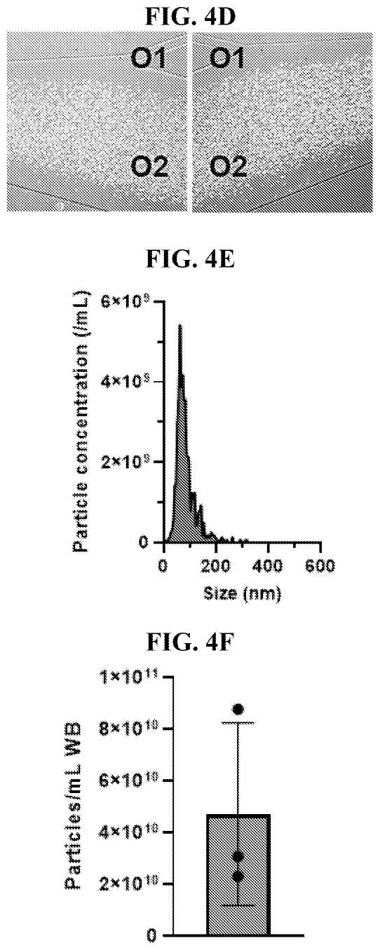

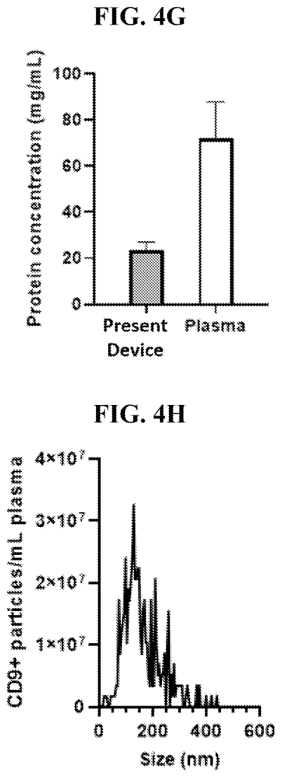

In one non-limiting example, blood (or blood diluted with sheath fluid) was introduced through the sample inlet toward the microchannel outer wall and pinched (against the microchannel outer wall) by a sheath flow using two peristaltic pumps (see FIG. 1B to 1D). Besides peristaltic pumps, other types of pumps (pressure pump, syringe pumps, etc.) may be used to introduce a sample (and also the sheath fluid). However, as flow progresses through the curved microchannel, bacteria (about 0.5 to 2 μm) experienced size-dependent Dean drag force (F_{D}) and wall induced lift force (F_{WL}) migrate laterally toward the microchannel inner wall and are sorted toward O1. Larger blood cells (more than 2 μm) migrate further away from the microchannel's inner wall and are sorted toward O2 as waste (˜10⁴⁻⁵ RBC depletion) (FIG. 1E). In such fluid flow, as the fluid flows through the semi-spiral-shaped channel, the fluid and particles therein experience centrifugal acceleration directed radially outward, leading to formation of two symmetrical counter-rotating Dean vortices, for example, at the top and bottom halves of the semi-spiral-shaped channel (e.g., FIG. 1B and FIG. 4A). Such Dean vortices imposes lateral Dean drag force (F_{D}), which confers superior separation of the particles as both forces F_{D} and F_{WL} may scale non-linearly with particles size.

### Example 2: Device Characterization

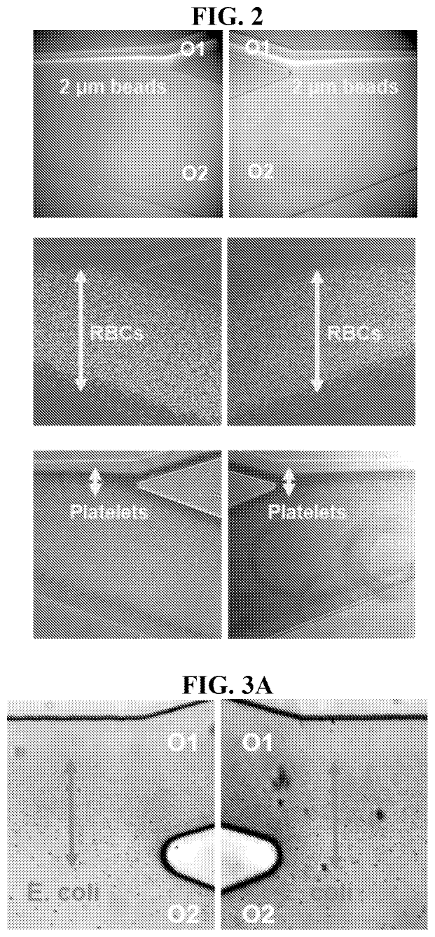

For device characterization, 2 μm polystyrene beads were perfused into sample inlet to mimic the trajectory of bacteria. Fluorescent imaging showed that 2 μm beads with faster migration speed were driven nearer to the microchannel's inner wall and eluted via inner outlet (O1) (FIG. 2 top row images). High speed images of diluted blood showed that platelets with medium size (2 to 4 μm) occupied slightly further position from inner wall (dark band) and were split into both outlets at the bifurcation. The larger RBCs (more than 6 μm) had the slowest migration speed due to Stoke's Drag and were sorted into O2 as waste (FIG. 2 center row and bottom row images).

### Example 3A: Discussion of Results for Bacteria Isolation

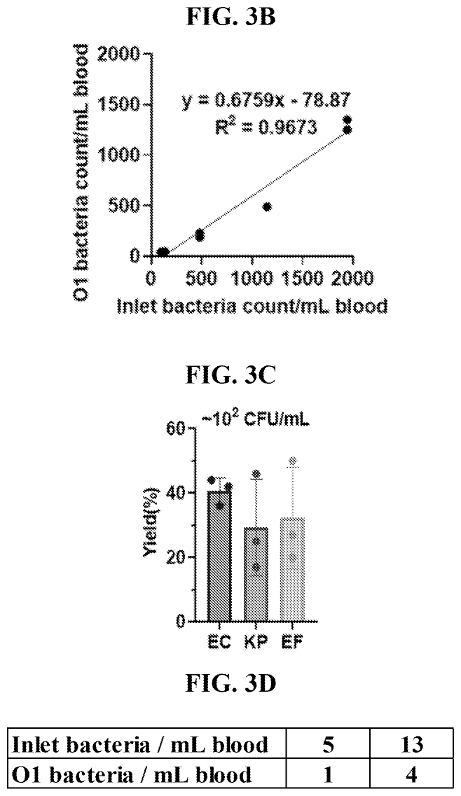

For bacteria isolation, 1:1 diluted blood (e.g., blood diluted with sheath fluid) spiked with bacteria (Escherichia coli (EC), Klebsiella pneumoniae (KP), Enterococcus faecalis (EF)) between 10 to 2000 CFU/mL whole blood (WB) was introduced toward the microchannel's outer wall and pinched by a sheath flow. High speed imaging showed that EC mimicked trajectory of 2 μm beads and were eluted into O1 (FIG. 3A). For bacteria characterization, eluted EC (O1) and inlet were cultured for 24 hours and CFU enumeration was performed. Linear regression of EC between 100 to 2000 CFU/mL WB bacterial load indicated high bacteria recovery of about 68% (FIG. 3B). At low bacteria concentrations (about 10 to 100 CFU/mL WB), presence of bacteria was successfully detected for all 11 samples (100% detection) spiked with different bacteria species (EC, n=5; KP and EF, n=3 each) with about 20 to 40% yield by processing 1 to 2 mL of blood (FIGS. 3C and 3D). These results clearly demonstrated that the developed microfluidic device offers a direct centrifuge-free solution for isolating low abundance bacteria (i.e. the bacteria is present at a low concentration to begin with).

### Example 3B: Discussion of Results for EVs and Virus Isolation

In this example, to isolate EVs (50 nm to 1000 nm) and viruses (30 nm to 500 nm) from blood, the microfluidic device of example 1 was modified to have hydraulic resistance of O1 (i.e. outlet 1—see FIG. 1A) increased by reducing its channel width (i.e. width of first outlet channel, such as width of the serpentine channel) and increasing its channel length (length of first outlet channel). The cut-off size of O1 was reduced to 500 nm to separate plasma, small EVs and viruses into O1 while deflecting large EVs (more than 500 nm), bacteria (0.5 to 2 μm), platelets into O2 (FIG. 4A). For bead characterization, more 50 nm beads (about 24%) were recovered in O1 (measured by nanoparticle tracking analysis (NTA)) compared to 500 nm beads (about 13%, measured by flow cytometry) (FIG. 4B), which was consistent with the fluorescent imaging showing partial elution of 500 nm beads into O2 (FIG. 4C). Device characterization using human blood further showed that large blood cells were successfully removed into O2 (FIG. 4D), while nanoparticles with size less than 200 nm were eluted into O1 at concentration of 4.7×10⁷ particles/mL WB (FIG. 4E, 4F). Due to 1:1 pre-dilution and on-chip sheath dilution, the eluted plasma O1 has lower protein concentration (about 23.4 mg/mL) compared to plasma (about 72 mg/mL) traditionally extracted using centrifugation (FIG. 4G). The on-chip dilution refers to dilution rendered by flow of sheath fluid with the sample blood, as the sheath fluid may inevitably enter the first outlet channel (denoted O1 in this instance-see FIG. 4D) with the sample. Besides blood processing, the present microfluidic device can also be used to remove residual cells or platelets in biobanked plasma traditionally extracted using centrifugation. ˜4×10⁷ CD9+ particles (EV marker, indicative of EVs) with size between 50 to 300 nm were isolated from 1 mL of biobanked plasma after processing using ExoArc, indicating successful separation of plasma with EVs from the large residual bioparticles (more than 500 nm). These results show that ExoArc provides a simple and centrifuge-free alternative for separation of plasma and small nanoparticles (less than 500 nm) from blood which can be readily automated for point-of-care clinical diagnostics.

### Example 3C: Discussion of Results for Virus Isolation

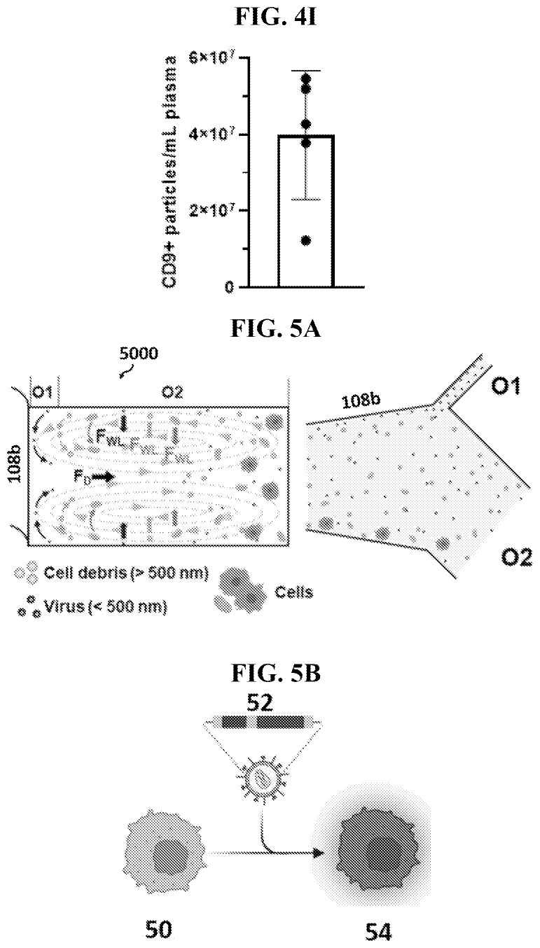

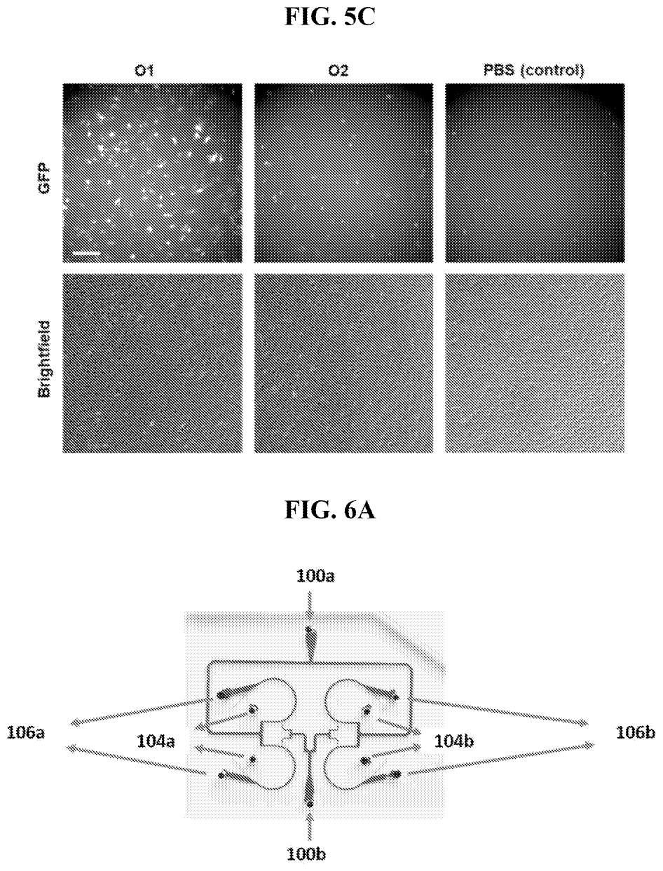

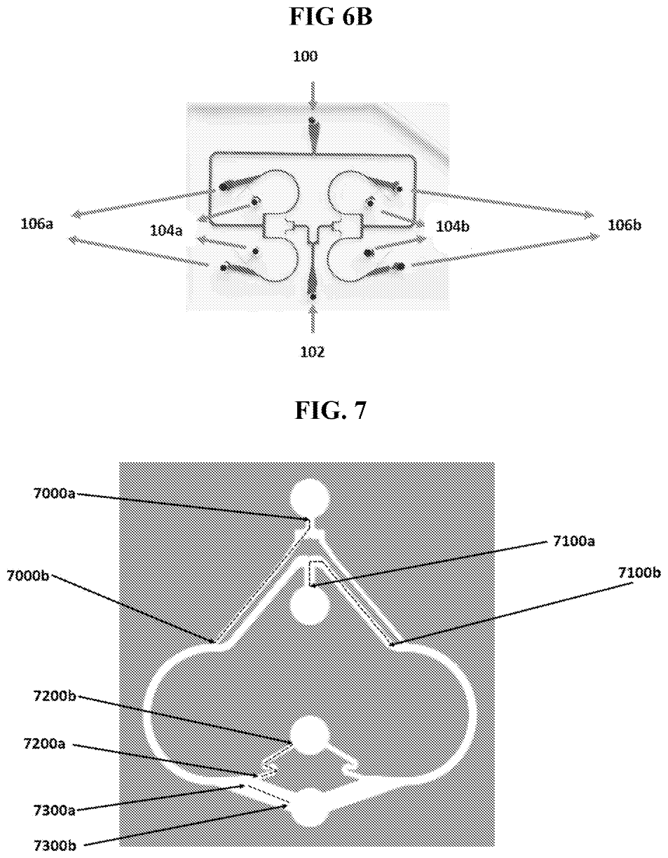

In this example, the microfluidic device (used in example 3B) was used to demonstrate low-volume virus isolation method from culture media. Viruses with similar size range to small EVs are separated into O1 while cell debris and cells are sorted into waste O2 (FIG. 5A). To evaluate the separation performance, plasmid of lentivirus was incorporated with green fluorescent protein (GFP) to visualize the viral transduction into the human aortic endothelial cells (HAoEC) (FIG. 5B). 400 μL of culture media containing virus was processed using the present microfluidic device and equal volume of O1 and O2 eluents were separately incubated with two batches of HAoEC. Phosphate buffer saline (PBS) was also used as negative control. After two days of culture, significant upregulation of GFP signal was observed in HAoEC incubated with O1 eluent compared to other HAoECs treated with O2 eluent and PBS control, thus indicating the successful isolation of lentivirus in O1 and the HAoEC transfection (FIG. 5C). The present virus isolation method is advantageous for the process monitoring to improve the consistency of virus production.

### Example 4: Summary and Applications

As mentioned above, sepsis is a highly prevalent disease due to bacterial infection and estimated 48.9 million cases and 11 million deaths were reported globally in 2017. Early detection of sepsis tends to be extremely paramount as the mortality rate increases by 7.6% every hour. The presently developed curved microfluidic device can accelerate sepsis diagnostics by directly isolating the low abundance bacteria from fresh blood onsite in 10 minutes, avoiding the lengthy process of sample transportation and centrifugation which defer the diagnostic process. The presently developed curved microfluidic device is also compatible with low blood volume (about 1 mL) which reduces patients' discomfort compared to traditional blood culture that requires more than 10 mL blood and takes up to about 48 hours.

Also, the presently developed technology enables sepsis detection in children having less blood volume than adults. The compact and automatable fluidic configuration of the present device advantageously allows easy integration with downstream detectors and deployment in clinical settings like hospitals or clinics for sepsis diagnostics.

Besides sepsis, liquid biopsies based on blood-borne EVs and viruses offer less invasive diagnostics for cancer and infectious disease detection compared to tissue biopsies. The presently developed device can simplify EV/viruses isolation by replacing the tedious multi-step centrifugation and reduce the inconsistency in blood processing. Residual cells in isolated EV/virus can be greatly minimized to enhance EV detection and testing of low viral load with low cellular DNA/RNA contamination in blood. For biomanufacturing, the low sample volume required by the present device also provides a more affordable isolation alternative for inline monitoring of EV/virus production. It offers better process control over individual segments of the manufacturing pipeline compared to the common endpoint quality control methods. Taken together, the presently developed microfluidic device demonstrates great flexibility and potential in isolating different micro/nanoparticles from blood or culture media for clinical diagnostics or biomanufacturing.

While the present disclosure has been particularly shown and described with reference to specific embodiments, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

1. A microfluidic device comprising:
semi-spiral-shaped channels in fluid communication with (i) at least two inlet ports and (ii) at least two outlet ports,
wherein the at least two inlet ports comprise:
a sample inlet port and a sheath inlet port,
wherein the sample inlet port is in fluid communication with sample inlet channels, each of the sample inlet channels is connected to one semi-spiral-shaped channel, and
wherein the sheath inlet port is in fluid communication with sheath inlet channels, each of the sheath inlet channels is connected to one semi-spiral-shaped channel;
wherein the at least two outlet ports comprise a first outlet port and each of the semi-spiral-shaped channels has a first outlet channel connected to the first outlet port, and
wherein each first outlet channel is longer than any other outlet channel connected to the same semi-spiral-shaped channel.

2. The microfluidic device of claim 1, wherein each of the sample inlet channels is connected proximal to an outer wall of the one semi-spiral-shaped channel, and wherein each of the sheath inlet channels is connected proximal to an inner wall of the one semi-spiral-shaped channel.

3. The microfluidic device of claim 1, wherein the sheath inlet port is configured to have a sheath fluid introduced at a higher flow rate than a sample introduced into the sample inlet port.

4. The microfluid device of claim 1, wherein the sheath inlet channels are configured to have a sheath fluid driven toward the semi-spiral-shaped channels at a higher flow rate than a sample in the sample inlet channels driven toward the semi-spiral-shaped channels.

5. The microfluidic device of claim 1, wherein the sample inlet port is defined as having a width of 50 μm to 1000 μm.

6. The microfluidic device of claim 1, wherein the sheath inlet port is defined as having a width of 50 μm to 1000 μm.

7. The microfluidic device of claim 1, wherein the sample inlet channels comprise two sample inlet channels, which are bifurcated from the sample inlet port to define the two sample inlet channels.

8. The microfluidic device of claim 1, wherein the sheath inlet channels comprise two sheath inlet channels, which are bifurcated from the sheath inlet port to define the two sheath inlet channels.

9. The microfluidic device of claim 1, wherein:
the sample inlet channels all have the same dimensions; and/or
the sheath inlet channels all have the same dimensions; and/or
the semi-spiral-shaped channels all have the same dimensions.

10. The microfluidic device of claim 1, wherein each of the sample inlet channels is defined as having a width of 50 μm to 1000 μm.

11. The microfluidic device of claim 1, wherein each of the sheath inlet channels is defined as having a width of 50 μm to 1000 μm.

12. The microfluidic device of claim 1, wherein each of the semi-spiral-shaped channels is defined as having:
a width of 200 μm to 1000 μm; and/or
a height of 30 μm to 300 μm; and/or
a length of 5 mm to 35 mm; and/or
a radius of curvature of 3 mm to 10 mm.

13. The microfluidic device of claim 1, wherein each first outlet channel is defined as having a width of 25 μm to 500 μm.

14. The microfluidic device of claim 1, wherein the at least two outlet ports comprise two outlet ports, wherein the two outlet ports include the first outlet port and a second outlet port, and wherein each of the semi-spiral-shaped channels has a second outlet channel connected to the second outlet port.

15. The microfluidic device of claim 14, wherein each second outlet channel is defined as having a width of 800 μm to 3000 μm.

16. A method for fractionating particles of different sizes, the method comprising:
providing the microfluidic device of claim 1;
introducing a sample into the sample inlet port and introducing a sheath fluid into the sheath inlet port to form a mixture in the semi-spiral-shaped channels;
driving the mixture through the semi-spiral-shaped channels; and
recovering a first fraction of particles from the first outlet port.

17. The method of claim 16, wherein introducing the sample into the sample inlet port and introducing the sheath fluid into the sheath inlet port comprise introducing the sheath fluid at a higher flow rate than the sample.

18. The method of claim 16, wherein introducing the sample into the sample inlet port and introducing the sheath fluid into the sheath inlet port comprises introducing the sample toward the outer wall of each of the semi-spiral-shaped channel and introducing the sheath fluid toward the inner wall of each of the semi-spiral-shaped channel.

19. The method of claim 16, wherein driving the mixture through the semi-spiral-shaped channels comprises driving the mixture to flow in each of the semi-spiral-shaped channels with (i) a Reynolds number of 20 to 500 and (ii) a Dean number of 2 to 50.

20. The method of claim 16, wherein recovering the first fraction of particles from the first outlet port comprises recovering particles in the same sample having the smallest diameters compared to particles recovered in any other outlet channel.
